(19) United States
(12) Patent Application Publication
(10) Pub. No.: US 2026/0266336 A1
(43) Pub. Date: Sep. 10, 2026

(54) SEALING DEVICE, IN PARTICULAR FOR A ROLLING BEARING AND ASSOCIATED

(71) Applicant: Aktiebolaget SKF, Goteborg (SE)

(72) Inventors: Piero SANTANGELO, Torino (IT); Enzo AMICO, Moncalieri (IT); Giuseppe GRASSI, Pinerolo (IT)

(21) Appl. No.: 19/549,299

(22) Filed: Feb. 25, 2026

(30) Foreign Application Priority Data
Mar. 4, 2025 (IT) 102025000004485

(51) Int. Cl. F16C 33/78

(52) U.S. Cl. CPC F16C 33/7889; F16C 2208/10; F16C 2220/04; F16C 2226/12

(57) ABSTRACT

A sealing device (1) includes an elastomeric annular element (2) and an annular support (3) arranged inside a radially middle portion (4) of the elastomeric element. The elastomeric annular element has an annular housing (8) having a bottom wall (9) and an opposite annular inlet opening (13). The elastomeric annular element has a first annular edge (14) radially bounding the inlet opening. The annular edge projects radially inwards and faces the bottom wall (9). The annular support (3) is made of a synthetic plastic material and is snap-engaged, without adhesives, together with the elastomeric annular element (2). The elastomeric annular element is disposed with radial interference within the annular housing (8) and is axially clamped therein so as to fill totally the annular housing (8).

### CROSS-REFERENCE TO RELATED APPLICATION

This application claims priority to Italian Patent Application No. 102025000004485, filed Mar. 4, 2025, the entirety of which is hereby incorporated by reference.

### FIELD

The present disclosure relates to a sealing device which can be inserted between two relatively rotating annular members so as to seal in a substantially fluid-tight manner the annular space bounded between these members. In particular, the sealing device can be inserted between the inner ring and outer ring of a rolling bearing. The present disclosure also relates to an associated method for the production of the sealing device.

### BACKGROUND

It is known that, in order to protect the rolling members of a rolling bearing, the annular space which houses them, bounded between an outer ring and an inner ring of the rolling bearing, is protected by at least one sealing device (or by a pair of specularly symmetrical sealing devices) which is (are) inserted between the outer ring and the inner ring of the bearing. More generally, it is known to use sealing devices inserted between two relatively rotating members in order to protect the annular space bounded between them.

The known sealing devices are generally formed by an annular sealing element, made of an elastomeric material and provided with one or more sealing lips, configured to exert during use a sliding contact or labyrinth sealing action on the rotating member, and by a, generally metallic, reinforcing support to which the sealing element is joined as one piece by means of co-moulding/bonding, for example vulcanization bonding.

The process in question is complex and costly. Moreover, it requires a lot of energy and the use of chemical substances, such as deoxidizing agents and primers. The metal pressing process moreover results in a large amount of waste material which cannot be used, unless recast, with the consequent emission of a large amount of CO₂. Moreover, the end-of-life disposal of the product is complex since an elastomeric element, such as a vulcanized rubber seal bonded to a metal support, cannot be recycled.

### SUMMARY

The object of the present disclosure is therefore to provide a sealing device which can be inserted between two relatively rotating members, for example the inner ring and outer ring of a rolling bearing, which does not have the aforementioned drawbacks, while ensuring a sealing performance and durability over time substantially matching that of the known sealing devices. It is also an object of the present disclosure to provide a method for obtaining such a sealing device, which is simple, rapid and low-cost.

According to the present disclosure a sealing device which can be inserted between two relatively rotating members, for example the inner ring and outer ring of a rolling bearing, and an associated method for the production thereof, having the characteristic features described in the attached claims, are provided.

### BRIEF DESCRIPTION OF THE DRAWINGS

The present disclosure will now be described with reference to the attached drawings which illustrate a non-limiting example of embodiment thereof, in which:

FIG. 1 shows in schematic form a perspective three-quarters front view of a sealing device provided in accordance with the present disclosure;

FIG. 2 shows in schematic form and on a larger scale a perspective view, identical to that of FIG. 1 and radially cross-sectioned, of a radially outer circumferential portion of a first component of the sealing device according to FIG. 1;

FIG. 3 shows in schematic form a radially sectioned elevation view of the component according to FIG. 2;

FIG. 4 shows in schematic form a radially sectioned elevation view of the sealing device according to FIG. 1;

FIG. 5 shows, on a larger scale, in the same perspective view as FIG. 1, a circumferential portion of the sealing device according to FIG. 1; and

FIG. 6 shows in schematic form on a larger scale, in the same radially sectioned elevation view as FIG. 3, the sealing device according to FIG. 1.

### DETAILED DESCRIPTION

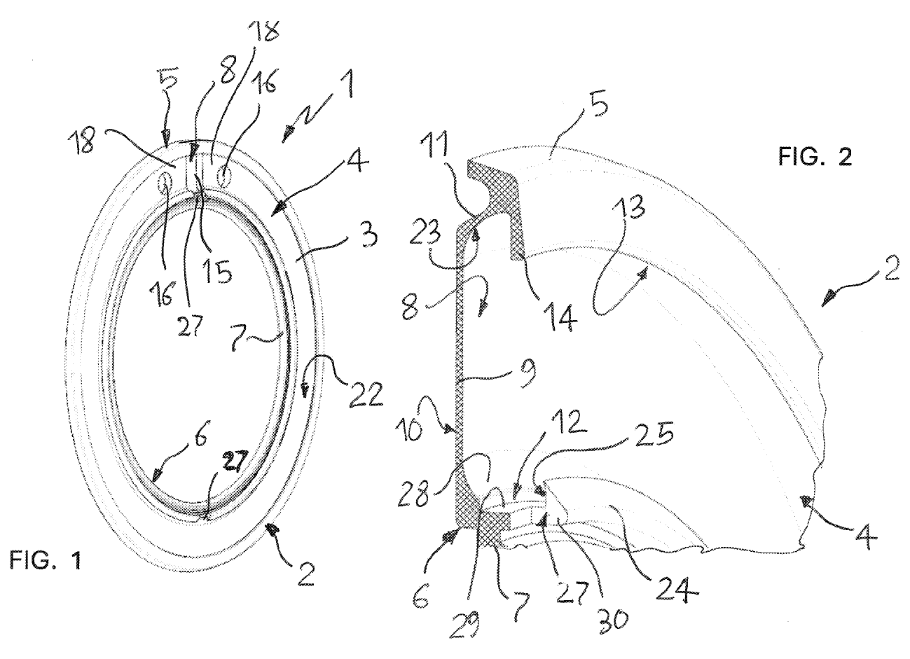

With reference to FIG. 1 to 6, in said figures, 1 denotes a sealing device configured to be insertable during use, in a known manner not shown for simpler illustration, between two relatively rotating annular members, known and also not shown for simpler illustration, for example the inner ring and outer ring of a rolling bearing.

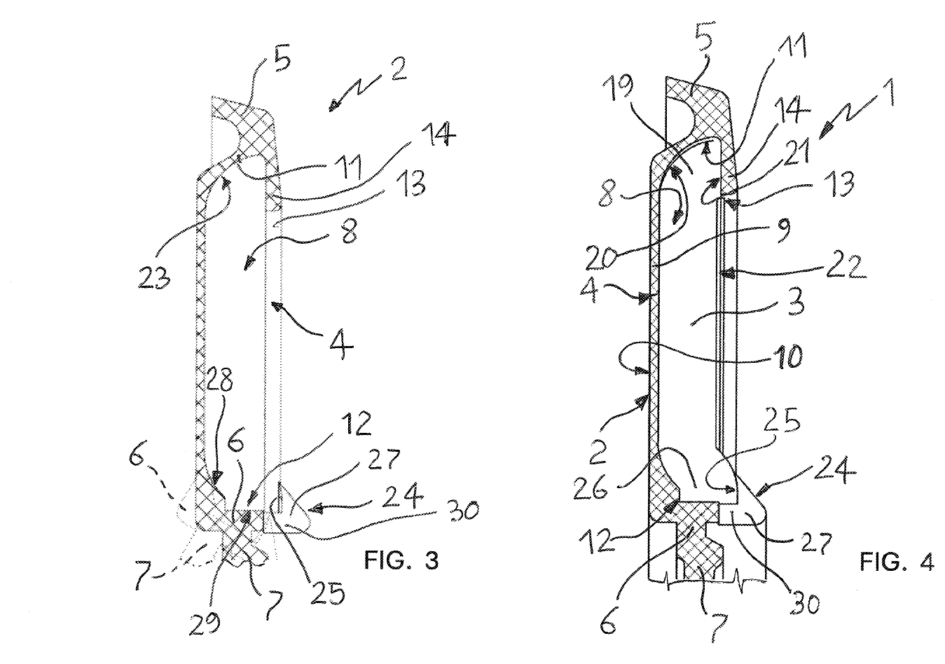

The sealing device 1 comprises an elastomeric annular sealing element 2 (FIGS. 2 and 3) and an annular support 3 integrally coupled to the elastomeric annular element 2 so as to be at least partly arranged inside the elastomeric annular element 2, in a radially middle portion 4 thereof (FIGS. 4 and 6).

The radially middle portion 4 is bounded between a radially outer peripheral portion 5 and a radially inner peripheral portion 6 of the elastomeric annular element 2.

The radially inner portion 6 of the elastomeric annular element 2 is also provided radially on the inside with at least one annular sealing lip 7 (FIGS. 2 and 6), known and not shown in its entirety for simpler illustration, also because the lip 7 may be configured, depending on requirements, as a sliding-contact lip, or as a non-contacting lip designed to exert during use a labyrinth sealing action.

According to a first aspect of the present disclosure, the radially middle portion 4 of the elastomeric annular element 2 is provided with an annular housing 8 (FIGS. 2 and 6) including (FIG. 2) a bottom wall 9 delimiting a first face 10 of the elastomeric annular element 2 and flanked by a first, radially outer, annular sidewall 11 and by a second, radially inner, annular sidewall 12 of the annular housing 8, facing each other.

The annular housing 8 is substantially in the form of a channel which is open at the top and therefore has, on the side opposite to the bottom wall 9, an annular inlet opening 13 bounded radially on the outside by a first annular edge 14 which extends radially projecting inwards from the radially outer peripheral portion, so as to face the bottom wall 9.

According to an important aspect of the present disclosure, the annular support 3, instead of being made of stamped metal, is in the form of an annular washer made entirely of a synthetic plastic material, for example by means of injection-moulding.

Moreover, according to the present disclosure, the annular support 3 is simply snap-engaged, without adhesives, together with the elastomeric annular element 2 in the manner which will be seen below, being inserted with radial interference within the annular housing 8, axially clamped between the bottom wall 9 and the first annular edge 14, so as to fill totally the annular housing 8.

The annular support 3 in the form of an annular washer is configured to be at least partially elastically deformable in a radial direction.

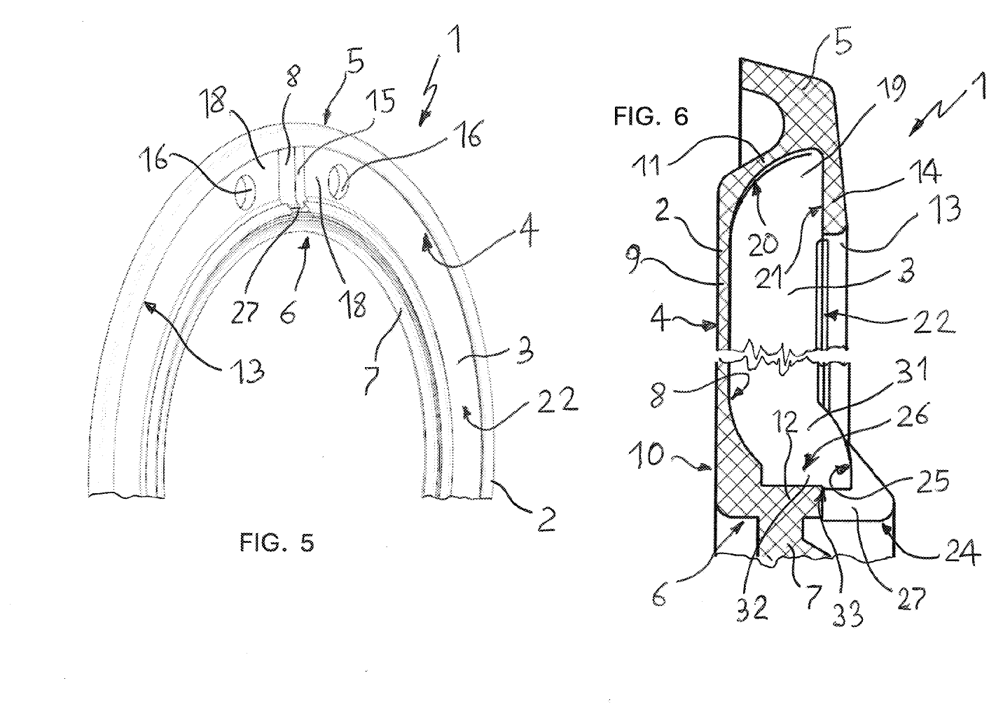

For this purpose, the annular support 3 in the form of an annular washer is provided with a radial notch 15 (FIGS. 1 and 5) configured to create in the annular support a circumferential gap which interrupts the continuity thereof.

The radial notch 15 is flanked by a pair of axial through-holes 16 (FIGS. 1 and 5) formed in opposite circumferential ends 18 of the annular support 3.

The annular support 3 is also configured so as to have a radially outer continuous annular outer edge 19 (FIGS. 4 and 6) bounded by a radially outer curved side surface 20 and by a radially outer annular section 21 of a first substantially flat face 22 of the annular support 3 opposite to the bottom wall 9 of the annular housing 8.

The annular sidewall 11 of the annular housing 8 is bounded by a curved surface 23 (FIGS. 2 and 3) mating with the radially outer curved side surface 20 of the annular support 3.

According to one aspect of the present disclosure, the annular support 3 has an outer diameter greater than the radially outer diameter of the annular housing 8, defined by the first radially outer annular sidewall 11 of the housing 8.

According to a further aspect of the present disclosure and in combination with that described hitherto, the annular inlet opening 13 of the annular housing 8 is radially bounded on the inside by a second annular edge 24 (FIGS. 2 and 6) which extends projecting radially outwards from the radially inner peripheral portion 6 of the elastomeric sealing element 2.

In this way, the annular edge 24 is at least partially facing or directed towards the bottom wall 9 of the annular housing 8.

The annular edge 24 has, viewed in radial cross section, a saw-tooth shape including a shoulder surface 25 directed towards the bottom wall 9 and is configured so as to form together with the second annular sidewall 12 of the annular housing 8 a snap-on lock for a radially inner continuous annular edge 26 (FIGS. 4 and 6) of the annular support 3.

According to one aspect of the present disclosure, the annular edge 24, which delimits radially on the inside the annular housing 8 formed in the elastomeric sealing element 2, extends axially projecting, i.e. is axially displaced, with respect to the first annular edge 14 of the inlet opening 13 of the annular housing 3, so that it only partially faces the edge 14.

In particular, the annular edge 24 is axially offset with respect to the edge 14 on the opposite side to the bottom wall 9 and is provided with at least a first radial groove 27 which interrupts it circumferentially and which extends axially also through part of the second annular sidewall 12 of the annular housing 8 (FIGS. 4 and 6). The first groove 27 is also aligned with the radial notch 15 of the annular support 3.

The second annular edge 24 which radially delimits on the inside the annular housing 8 preferably comprises (FIG. 1) at least one second radial groove 27 which interrupts it circumferentially and which is specularly symmetrical with the first radial groove 27 and arranged diametrically opposite it.

The second annular sidewall 12 of the annular housing 8 (FIGS. 2 and 3) comprises a first, radially outer, annular section 28 bounded by a curved surface which connects with the bottom wall 9 and which extends radially on the outside beyond the shoulder surface 25 of the edge 24.

The second annular sidewall 12 of the annular housing 8 (FIGS. 2 and 3) also comprises a second, radially inner, annular section 29, consisting of a step-shaped recess and extending substantially flush with the root portion 30 of the second annular edge 24.

The radially inner continuous annular edge 26 of the annular support 3 is shaped, viewed in radial cross section, as a support foot for the said annular support 3, said support foot extending at least partially axially projecting with respect to the radially outer continuous annular edge 19 of the annular support 3.

The support edge or foot 26 is formed by (FIG. 6) a first, radially outer, annular section 31, bounded by opposite curved surfaces, which are situated opposite the radially outer curved side surface 20 delimiting the radially outer continuous annular edge 19 of the annular support 3, so that the section 31 is radially enlarged, and by a second, radially inner, annular section 32 which has, viewed in radial cross section, a cylindrical sleeve shape axially offset from the radially outer continuous annular edge 19 on the opposite side to the bottom wall 9 of the annular housing 8.

The annular section 32 is provided with a radial step 33 (FIG. 6) which allows it to engage with the sidewall 12 of the housing 8 opposite the annular edge 24.

From that described, it is clear that the present disclosure also includes a method for making a sealing device 1 according to the present disclosure comprising an elastomeric annular sealing element 2 and an annular support 3 integrally coupled to the elastomeric annular element 2 so as to be at least partly arranged inside the elastomeric annular element 2, comprising the following steps:
i) injection-moulding or compression-moulding, in a known manner therefore not described for simpler illustration, the elastomeric annular element 2 forming an annular housing 8 for the annular support 3 in a radially middle portion 4 of the elastomeric annular element 2 bounded between a radially outer peripheral portion 5 and a radially inner peripheral portion 6 of the elastomeric annular element 2, the radially inner portion 6 of the elastomeric annular element 2 being provided radially on the inside with at least one annular sealing lip 7, shown only partly, which may be of any known type;
ii) moulding, for example injection-moulding, using a synthetic plastic material the annular support 3 shaped as a substantially flat washer, but with a shape matching that of the annular housing 8, except that it has an outer diameter slightly greater than an outer diameter of a radially outer sidewall 11 of the annular housing 8 and provided with a radial notch 15 which interrupts the circumferential continuity thereof, the radial notch 15 being flanked by a pair of axial through-holes 16 formed in opposite circumferential ends 18 of the annular support 3;
iii) snap-engaging, without applying adhesives, the annular support 3 inside the annular housing 8, axially clamping it between a bottom wall 9 and a first radially outer annular edge 14 of the annular housing 8 so as to fill totally the annular housing 8 with the annular support 3;

the step iii being carried out by moving the opposite circumferential ends 18 of the annular support 3 closer together by means of the axial holes 16 using a suitable tool (not shown for simpler illustration, for example pliers of the type used to mount the elastic axial locking rings) and partially rotating the radially inner portion 6 of the elastomeric annular element 2 FIG. 3, element shown in broken lines) on the side of the bottom wall 9 of the annular housing 8, preferably by manipulating at least one sealing lip 7.

From the above description, it is clear that, owing to the geometrical forms and structures used, the following advantages are obtained:
1- the process for production of the polymer insert acting as a support 3 is simpler than the current process using metal supports and requires a limited investment in tools (only multi-figure injection moulds);
2- in energy terms, the production process using injection-moulding is more favourable than the current pressing of metal inserts and is also ecological since chemical products (phosphating, degreasing, primers, etc.) are not required;
3- the injection-moulding process may reuse up to 50% of the waste material;
4- the end product (sealing device) is 100% recyclable and is easy to separate from the bearing on which it is mounted during use, owing to the fact that the plastic support 3 and elastomeric sealing element 2 are joined together only mechanically;
5- less emission of CO₂, with 60 to 70% reduction of CO₂, for the entire production cycle/life of the product;
6- the hydraulic sealing efficiency of the sealing device remains unchanged compared to similar known sealing devices provided with metal supports.

All the objects of the present disclosure are therefore achieved.

What is claimed is:

1. A sealing device insertable between inner and outer rings of a rolling bearing, the sealing device comprising:
an elastomeric annular sealing element having a radially outer peripheral portion, a radially middle portion, and a radially inner peripheral portion, the radially inner peripheral portion having at least one annular sealing lip on a radial inside of the radially inner peripheral portion, the radially middle portion including an annular housing having a bottom wall delimiting a first face of the elastomeric annular element, the annular housing having a radially outer first annular sidewall and a radially inner second annular sidewall, the first and second annular sidewalls facing one another, the bottom wall being flanked by the first annular sidewall and by the second annular sidewall, the annular housing also having a first annular edge and an annular inlet opening on the side opposite to the bottom wall, the annular inlet opening being bounded radially on the outside by the first annular edge, the first annular edge projecting radially inwards from the radially outer peripheral portion and facing the bottom wall; and
an annular support integrally coupled to the elastomeric annular sealing element so as to be at least partially arranged inside the elastomeric annular sealing element in the radially middle portion, the annular support being bounded between the radially outer peripheral portion and the radially inner peripheral portion of the elastomeric annular element, the annular support being an annular washer made of a synthetic plastic material, the annular support being snap-engaged, without adhesives, with the elastomeric annular element, the annular support being disposed with radial interference within said annular housing and axially clamped between said bottom wall and said first annular edge so as to totally fill the annular housing.

2. The sealing device according to claim 1, wherein the annular support is at least partially elastically deformable in the radial direction, the annular support including a radial notch creating in the annular support a circumferential gap interrupting the continuity of the annular support, the radial notch being flanked by a pair of axial through-holes formed in opposite circumferential ends of the annular support.

3. The sealing device according to claim 1, wherein the annular support has a radially outer continuous annular edge, the radially outer continuous annular edge being bounded by a radially outer curved side surface and by a radially outer annular section of a first substantially flat face of the annular support opposite to the bottom wall of the annular housing, and wherein the first annular sidewall of the annular housing is bounded by a curved surface mating with said radially outer curved side surface of the annular support.

4. The sealing device according to claim 1, wherein the annular support has an outer diameter greater than a radially outer diameter of the annular housing defined by said first annular sidewall.

5. The sealing device according to claim 1, wherein the annular housing includes a second annular edge, the annular inlet opening of the annular housing being radially bounded on the inside by the second annular edge, the second annular edge projecting radially outwards from said radially inner peripheral portion of the elastomeric sealing element and facing the bottom wall, the second annular edge having a sawtooth shape when viewed in radial cross section, the sawtooth shape including a shoulder surface facing the bottom wall, the annular support having a radially inner continuous annular edge, the shoulder and the second annular sidewall of the annular housing being configured to form a snap-on lock for the radially inner continuous annular edge of the annular support.

6. The sealing device according to claim 5, wherein the second annular edge radially delimits the inside the annular housing of the elastomeric sealing element, the second annular edge axially projects with respect to the first annular edge of the annular housing on the side opposite to the bottom wall, the second annular edge has a first radial groove circumferentially interrupting the second annular edge, the first radial groove extending axially through part of said second annular sidewall of the annular housing.

7. The sealing device according to claim 6, wherein the second annular edge comprises a second radial groove circumferentially interrupting the second annular edge, the second radial groove being specularly symmetrical with the first radial groove and being arranged diametrically opposite to the first radial groove.

8. The sealing device according to claim 5, wherein the second annular edge has a root portion, wherein the second annular sidewall of the annular housing includes a first radially outer annular section and a second radially inner annular section, the first annular section being bounded by a curved surface which connects with the bottom wall and which extends radially on the outside beyond said shoulder surface, the second annular section having a step-shaped recess and extending axially substantially flush with the root portion of said second annular edge.

9. The sealing device according to claim 8, wherein the annular support has a radially outer continuous annular edge, the radially outer continuous annular edge being delimited by a radially outer curved side surface;
wherein the radially inner continuous annular edge of the annular support forms, when viewed in radial cross section, a support foot for the annular support, the support foot axially projects with respect to the radially outer continuous annular edge of the annular support, the support foot being formed by:
a first radially outer annular section bounded by opposite curved surfaces, the curved surfaces being opposite to the radially outer curved side surface delimiting the radially outer continuous annular edge of the annular support; and
a second radially inner annular section having a cylindrical sleeve shape when viewed in radial cross section, the second radially inner annular section being axially offset from the radially outer continuous annular edge toward the opposite side to said bottom wall of the annular housing.

10. The sealing device according to claim 2, wherein the annular support has a radially outer continuous annular edge, the radially outer continuous annular edge being bounded by a radially outer curved side surface and by a radially outer annular section of a first substantially flat face of the annular support opposite to the bottom wall of the annular housing, and wherein the first annular sidewall of the annular housing is bounded by a curved surface mating with said radially outer curved side surface of the annular support.

11. The sealing device according to claim 10, wherein the annular support has an outer diameter greater than a radially outer diameter of the annular housing defined by said first annular sidewall.

12. The sealing device according to claim 11, wherein the annular housing includes a second annular edge, the annular inlet opening of the annular housing being radially bounded on the inside by the second annular edge, the second annular edge projecting radially outwards from said radially inner peripheral portion of the elastomeric sealing element and facing the bottom wall, the second annular edge having a sawtooth shape when viewed in radial cross section, the sawtooth shape including a shoulder surface facing the bottom wall, the annular support having a radially inner continuous annular edge, the shoulder and the second annular sidewall of the annular housing being configured to form a snap-on lock for the radially inner continuous annular edge of the annular support.

13. The sealing device according to claim 12, wherein the second annular edge radially delimits the inside the annular housing of the elastomeric sealing element, the second annular edge axially projects with respect to the first annular edge of the annular housing on the side opposite to the bottom wall, the second annular edge has a first radial groove circumferentially interrupting the second annular edge, the first radial groove extending axially through part of said second annular sidewall of the annular housing.

14. The sealing device according to claim 13, wherein the second annular edge comprises a second radial groove circumferentially interrupting the second annular edge, the second radial groove being specularly symmetrical with the first radial groove and being arranged diametrically opposite to the first radial groove.

15. The sealing device according to claim 14, wherein the second annular edge has a root portion, wherein the second annular sidewall of the annular housing includes a first radially outer annular section and a second radially inner annular section, the first annular section being bounded by a curved surface which connects with the bottom wall and which extends radially on the outside beyond said shoulder surface, the second annular section having a step-shaped recess and extending axially substantially flush with the root portion of said second annular edge.

16. The sealing device according to claim 15, wherein the radially inner continuous annular edge of the annular support forms, when viewed in radial cross section, a support foot for the annular support, the support foot axially projects with respect to the radially outer continuous annular edge of the annular support, the support foot being formed by:
a first radially outer annular section bounded by opposite curved surfaces, the curved surfaces being opposite to the radially outer curved side surface bounding the radially outer continuous annular edge of the annular support; and
a second radially inner annular section having a cylindrical sleeve shape when viewed in radial cross section, the second radially inner annular section being axially offset from the radially outer continuous annular edge toward the opposite side to said bottom wall of the annular housing.

17. A method for making a sealing device comprising:
injection-moulding or compression-moulding an elastomeric annular element, said injection-moulding or compression-moulding forming an annular housing of the elastomeric annular element for an annular support in a radially middle portion of the elastomeric annular element, the elastomeric annular element having a radially outer peripheral portion and a radially inner peripheral portion, the radially middle portion being bounded between the radially outer peripheral portion and the radially inner peripheral portion, the radially inner portion having at least one annular sealing lip on a radial inside of the radially inner peripheral portion;
moulding using a synthetic plastic material the annular support in the form of a washer having a shape matching that of the annular housing of the elastomeric annular element, but with an outer diameter slightly greater than an outer diameter of a radially outer sidewall of the annular housing and having a radial notch interrupting circumferential continuity of the annular support, the radial notch being flanked by a pair of axial through-holes formed in opposite circumferential ends of the annular support;
snap-engaging, without the application of adhesives, the annular support inside the annular housing of the elastomeric annular element, the annular support being axially clamped between a bottom wall and a first radially outer annular edge of the annular housing, the annular housing being totally filled with the annular support, said snap-engaging comprising:
using a tool to move said opposite circumferential ends of the annular support closer together via the axial holes; and
partially rotating the radially inner portion of the elastomeric annular element on the side of the bottom wall of the annular housing.

18. The method of claim 17, wherein said partially rotating the radially inner portion of the elastomeric annular element comprises manipulating said at least one sealing lip.
